(19) United States
(12) Patent Application Publication
(10) Pub. No.: US 2007/0193077 A1
(43) Pub. Date: Aug. 23, 2007

(54) Wall calendar holder

(76) Inventor: Kathy Alane Brown, Calais, VT (US)

Correspondence Address: Kathy A. Brown, 2546 VT Route 14, N. Montpelier, VT, 05666, US

(21) Appl. No.: 11/326,794

(22) Filed: Jan. 6, 2006

(51) Int. Cl. G09D 3/04

(52) U.S. Cl. 40/119

(57) ABSTRACT

A wall calendar holder including a support backing with an upper portion, upper corner regions, corner pockets, a back portion, and an eyelet. The corner pockets are attached to the upper corner regions of the support backing, and the eyelet is disposed in the center of the upper portion of the support backing, such that the wall calendar holder hangs evenly from a nail or hook when in use with a standard wall calendar. The wall calendar holder may further include a back pocket where the back pocket is attached to the back portion of the support backing. Alternatively, the wall calendar holder may include a top pocket instead of corner pockets. The top pocket would be attached to the upper portion of the support backing.

### FIELD OF INVENTION

This invention currently relates to printed wall calendars, specifically to a wall calendar holder.

### BACKGROUND OF THE INVENTION

Wall calendars are designed to hang on the wall by means of a hole in the top center of the calendar and a nail or hook which the user installs on the wall, and usually include pictures which appeal to the user. The pictures are usually on the top half of the calendar with the calendar dates printed on the bottom half. Sometimes the calendar dates are printed on both the top and bottom half of the calendar. These calendars are often printed on thin paper with a hole in the top center of the calendar. The paper used is not heavy enough to stay upright against the wall with only the center hole hung on a nail or hook, which allows the top corners of the pages to droop or curl inward and downward towards the center of the calendar, thus obstructing the contents of the page and causing an unaesthetic look. Therefore, there is a need for a way to prevent the top corners of a calendar from drooping or curl inward and downward.

Another problem with typical wall calendars is that the pages tend to rip at the center hole due to the thinness of the pages and the weight of the calendar, and therefore cannot display the appropriate month because the ripped page keeps falling down. Therefore, there is a need to prevent the center holes from ripping when hung from a nail or hook. Additionally, some calendars, such as school calendars, which identify school vacations, holidays, dates that report cards are issued, etc., are typically issued at the beginning of a school year and parents will write the significant dates on the wall calendar. However, typical wall calendars usually display January-December, while the typical school calendar displays dates from August-June. Therefore, an individual is only able to write the school dates from August-December on their current wall calendar. Often, the calendars issued by the school are a one-page listing of important dates and often gets misplaced or thrown out during the course of the school year. Therefore, there is a need to provide a way to keep track of other calendars and papers, such as a school calendar, throughout the school year.

### SUMMARY

The invention is a wall calendar holder including: a support backing that has an upper portion upper, corner regions, corner pockets, a back portion, and an eyelet. The corner pockets are attached to the upper corner regions of the support backing, and the eyelet is disposed in the center of the upper portion of the support backing, such that the wall calendar holder hangs evenly from a nail or hook when in use with a standard wall calendar. The wall calendar holder may further include a back pocket where the back pocket is attached to the back portion of the support backing. Alternatively, the wall calendar holder may include a top pocket instead of corner pockets. The top pocket would be attached to the upper portion of the support backing.

In use, a user positions the wall calendar on top of and square with the wall calendar holder, inserts the upper corners of the wall calendar into the corner pockets of the wall calendar holder. Then the user hangs the wall calendar attached to the wall calendar holder to a surface for display. As the calendar months expire, the user turns the expired pages of the wall calendar as the pages expire, and then inserts the bottom corners of the expired pages into the corner pockets. Additionally, if the user has an insert, the user inserts it into the back pocket that is attached to the back portion.

Alternatively, if the user has a wall calendar with a top pocket instead of corner pockets, the user inserts the upper portion of the wall calendar into the top pocket of the wall calendar holder to secure it and then hangs the wall calendar attached to the wall calendar holder to a surface for display. As calendar pages expire, the user turns the expired pages of the wall calendar, and then inserts the bottom portion of the expired pages into the top pocket.

### BRIEF DESCRIPTION OF FIGURES

FIG. 1A is a front view of the wall calendar holder of the present invention.

FIG. 1B is a back view of the wall calendar holder of the present invention.

FIG. 1C is a view of the wall calendar holder of the present invention in use.

FIG. 2 is a front view of an alternate embodiment of the wall calendar holder of the present invention.

### DETAILED DESCRIPTION

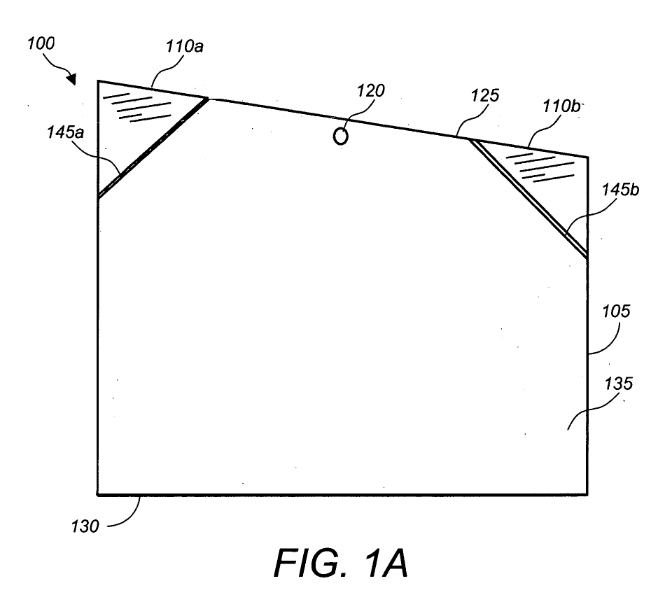

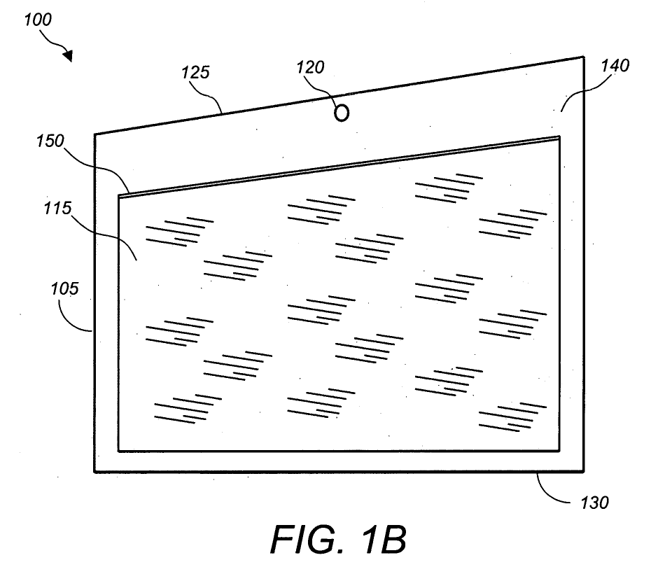

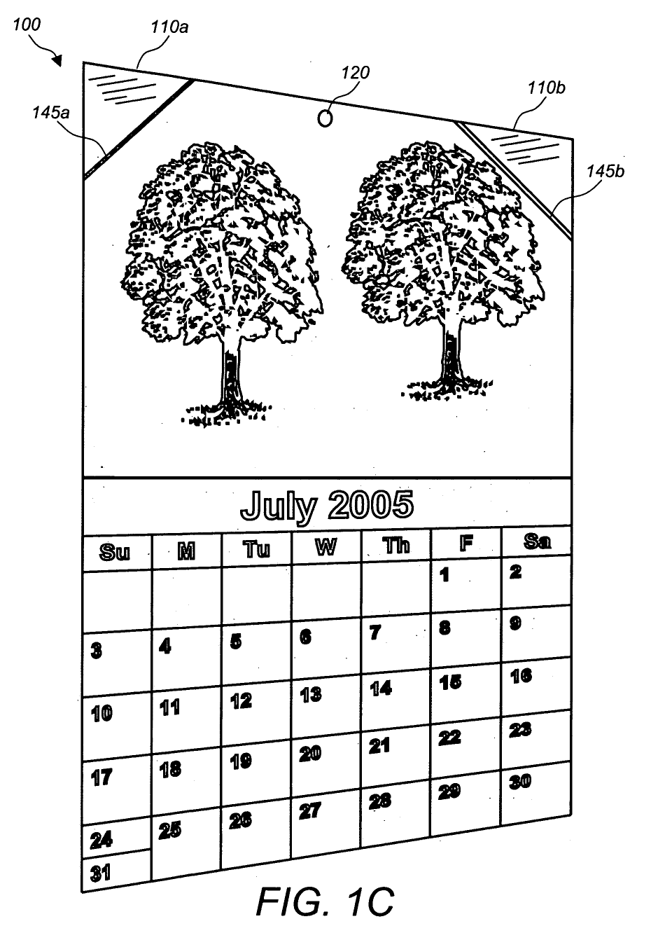

With reference to FIG. 1A, FIG. 1B, and FIG. 1C, a preferred embodiment wall calendar holder (100) includes support backing (105), corner pockets (110a and 110b), back pocket (115), and eyelet (120). Support backing (105) includes an upper region (125), a lower region (130), a front region (135), and a back region (140). Corner pockets (110a and 110b) include open regions (145a and 145b) respectively. Back pocket (115) further includes open region (150) which can be on either the top of back pocket (115) as shown, or on either side of back pocket (115).

Support backing (105) is preferably made of a thin lightweight rigid plastic material; however, any other suitable material such as wood, metal, poster board, cardboard, etc. may be used.

Eyelet (120) is disposed in the center of upper region (125) of support backing (105). Eyelet (120) is positioned such that it allows wall calendar holder (100) to hang evenly from a nail or hook when in use. Eyelet (120) is any conventional eyelet and allows for added hole reinforcement and support when wall calendar holder (100) is in use with a typical wall calendar and hung from a nail, screw, hook, tack, push pin, etc.

Corner pockets (110a and 110b) are fixedly attached to front region (135) of support backing (105) in the right and left hand corners respectively of upper region (125). Corner pockets (110a and 110b) may be attached by an adhesive or any other suitable attachment means such as hot melt, bonding, etc. Corner pockets (110a and 110b) are positioned such that when wall calendar holder (100) is in use with a typical wall calendar, the corners of the pages for expired months can be inserted into open regions (145a and 145b) of corner pockets (110a and 110b) allowing the page to be held securely in place, and therefore prevents page curling and/or drooping. Corner pockets (110a and 110b) are preferably made of a transparent plastic material to allow a user to view the full contents of the page; however, any color may be used and any suitable material, such as paper, plastic, poster board, etc., may be used.

Back pocket (115) is attached to back region (140) of support backing (105), preferably by an adhesive, or any other suitable means, such as hot melt, bonding, etc. Back pocket (115) is preferably made of a thin transparent plastic material to allow a user to view the contents without having to remove the insert; however, any color may be used and any suitable material, such as paper, plastic, poster board, etc., may be used. Back pocket (115) is positioned on back region (140) of support backing (105), such that it may accept an insert, such as an 8.5 inch×11 inch piece of paper through open region (150). However, back pocket (115) may accept inserts of other sizes.

In use, a user positions a typical wall calendar on front region (135) of wall calendar holder (100) such that eyelet (120) is aligned with the center hanging hole of the typical wall calendar. The top corners of the typical wall calendar's cover page are inserted into the open regions (145a and 145b) of corner pockets (110a and 110b). This secures the cover page of the typical wall calendar in place. If there is an insert, such as a school calendar, the insert is inserted into open region (150) of back pocket (115). Wall calendar holder (100) with the attached typical wall calendar is attached to the desired surface, such as a wall, by inserting any conventional means used to attach a typical wall calendar to a wall, such as a nail, screw, hook, tack, push pin, etc., through eyelet (120). As a month expires, the user turns the page of the expired month to display the following month and inserts the corners of the turned page into open regions (145a and 145b) of corner pockets (110a and 110b) to hold the page of the expired month securely in place, thus allowing the following month to be to be displayed and viewed unobstructed. If a user desires to see the insert, he/she simply removes the insert from open region (150) of back pocket (115) to view it, or turns the calendar around to view the insert through transparent back pocket (115).

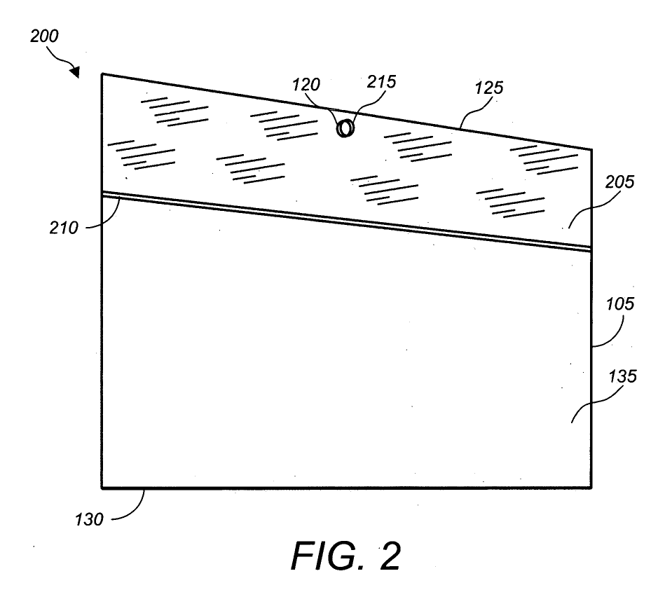

With reference to FIG. 2, in an alternate embodiment wall calendar holder (200) includes support backing (105), top pocket (205), back pocket (115), and eyelet (120). Support backing (105) includes an upper region (125), a lower region (130), a front region (135), and a back region (140). Top pocket (205) includes an open region (210). Back pocket (115) further includes open region (150).

Top pocket (205) is attached to front region (135) of support backing (105) along the entire length of upper region (125). Top pocket (205) may be attached by an adhesive, or any other suitable attachment means, such as hot melt, bonding, etc. Top pocket (205) is positioned such that when wall calendar holder (100) is in use with a typical wall calendar, the bottom portion of pages for expired months can be inserted into open region (210) of top pocket (205) allowing the page to be held securely in place, and therefore prevents page curling and/or drooping. Top pocket (205) is preferably made of a transparent plastic material to allow a user to view the full contents of the page; however, any color may be used and any suitable material, such as paper, plastic, poster board, etc. may be used. Top pocket (205) further includes a pocket hole (215) to allow for the attachment mechanism, such as a nail, screw, hook, tack, push pin, etc. to pass through top pocket (205).

In use, a user positions a typical wall calendar squarely on front region (135) of wall calendar holder (100) such that eyelet (120) and pocket hole (215) is aligned with the center hanging hole of the typical wall calendar. The top of the typical wall calendar's cover page is inserted into the open region (210) of top pocket (205). This secures the cover page of the typical wall calendar in place. If there is an insert, such as a school calendar, the insert is inserted into open region (150) of back pocket (115). Wall calendar holder (100) with the attached typical wall calendar is attached to the desired surface, such as a wall, by inserting any conventional means used to attach a typical wall calendar to a wall, such as a nail, screw, hook, tack, push pin, etc., through eyelet (120) and pocket hole (215). As a month expires, the user turns the page of the expired month to display the following month and inserts the bottom portion of the turned page into open region (210) of top pocket (205) to hold the page of the expired month securely in place, thus allowing the following month to be to be displayed and viewed unobstructed.

Additional embodiments may include a transparent protective cover sheet to cover the entire length of the wall calendar when displayed. Alternatively, the transparent cover sheet may only cover the top half of the wall calendar when displayed to protect the picture or graphic displays of the calendar. This would allow a user to protect the calendar while being displayed and also allow a user to make notes with an erasable marker or like device on the protective sheet without actually marking on the calendar itself. The protective cover sheet is preferably made of a thin plastic washable material, thus allowing a user to clean any markings or debris from the protective cover sheet.

Additionally, the present invention may be manufactured as part of the calendar and not a separate piece to be added later. For example, the corner pockets or top pocket may be attached directly to the cover page of a typical wall calendar, and a back pocket attached to the back portion of the cover page or alternatively to the back portion of the last page of the typical wall calendar.

It will be appreciated that the invention is not restricted to the particular embodiments that has been described, and that variations may be made therein without departing from the scope of the invention as defined in the claims and equivalents thereof.

I claim:

1) A wall calendar holder, comprising:
a) a support backing, comprising,
i) an upper portion;
ii) upper corner regions;
iii) a back portion; and
b) a plurality of corner pockets;
c) an eyelet; and
wherein, said plurality of corner pockets are attached to said upper corner regions of said support backing, and said eyelet is disposed in the center of said upper portion of said support backing, such that said wall calendar holder hangs evenly from a nail or hook when in use with a wall calendar.

2) The wall calendar holder of claim 1, further comprising:
a) a back pocket; and
wherein, said back pocket is attached to said back portion of said support backing.

3) A wall calendar holder, comprising:
a) a support backing, comprising,
i) an upper portion;
ii) a back portion; and
b) one or more top pockets;
c) an eyelet; and
wherein, said top pocket is attached to said upper portion of said support backing, and said eyelet is disposed in the center of said upper portion of said support backing, such that said wall calendar holder hangs evenly from a nail or hook when in use with a wall calendar.

4) The wall calendar holder of claim 3, further comprising:
a) a back pocket; and
wherein, said back pocket is attached to said back portion of said support backing.

5) A method of using a wall calendar holder, including:
a) positioning said wall calendar squarely on top of said wall calendar holder;
b) inserting upper corners of said wall calendar into corner pockets of said wall calendar holder;
c) hanging said wall calendar attached to said wall calendar holder to a surface for display;
d) turning expired pages of said wall calendar as said pages expire; and
e) inserting bottom corners of said expired pages into said corner pockets.

6) A method of claim 5, including:
a) inserting an insert into a back pocket attached to a back portion of said wall calendar holder.
